(19) United States
(12) Patent Application Publication
(10) Pub. No.: US 2025/0188211 A1
(43) Pub. Date: Jun. 12, 2025

(54) METHOD FOR MAKING FLUOROPOLYMERS CONTAINING ION EXCHANGE GROUPS

(71) Applicant: SOLVAY SPECIALTY POLYMERS ITALY S.P.A., Bollate (Milano) (IT)

(72) Inventors: Claudio Oldani, Parabiago (MI) (IT); Stefano Tonella, Corbetta (MI) (IT)

(73) Assignee: SOLVAY SPECIALTY POLYMERS ITALY S.P.A., Bollate (Milano) (IT)

(21) Appl. No.: 18/843,665

(22) PCT Filed: Feb. 27, 2023
(86) PCT No.: PCT/EP2023/054775

§ 371 Date: Sep. 3, 2024

(30) Foreign Application Priority Data
Mar. 1, 2022 (EP) 22159375.9

(51) Int. Cl. C08F 214/26; C08F 2/26; C08F 8/12

(52) U.S. Cl. CPC C08F 214/262; C08F 2/26; C08F 8/12

(57) ABSTRACT

The invention pertains to a method of making fluoropolymers comprising ion exchange groups using certain polymeric derivatives including a plurality of ionic groups selected from the group consisting of —SO₃Xₐ and —COOXₐ, whereas Xₐ is H, an ammonium group or a monovalent metal. The invention further relates to fluoropolymer dispersions comprising the fluorinated polymer with ion exchange groups and the polymeric derivative including ionic groups.

### REFERENCE TO RELATED APPLICATIONS

This application claims priority from European patent application EP22159375.9 filed on Mar. 1, 2022, the whole content of this application being incorporated herein by reference for all purposes.

### TECHNICAL FIELD

The present invention relates to a method of making fluoropolymer dispersions using certain polyfunctional polymeric derivatives, and to the fluoropolymers obtained therefrom.

### BACKGROUND ART

Fluoropolymers, i.e. polymers having a fluorinated backbone, have been long known and have been used in a variety of applications because of several desirable properties such as heat resistance, chemical resistance, weatherability, UV-stability etc. Fluorinated polymers comprising ion exchange groups have been used for the manufacture of proton exchange membranes, for instance for use in fuel cell applications.

A frequently used method for producing fluoropolymers involves aqueous emulsion polymerization of one or more fluorinated monomers generally involving the use of fluorinated surfactants. Frequently used fluorinated surfactants include perfluorooctanoic acids and salts thereof, in particular ammonium perfluorooctanoic acid.

Recently, perfluoroalkanoic acids having 8 or more carbon atoms have raised environmental concerns. For instance, perfluoroalkanoic acids have been found to show bioaccumulation. Accordingly, efforts are now devoted to phasing out such compounds and methods have been developed to manufacture fluoropolymer products using alternative surfactants having a more favourable toxicological profile.

EP 0341716 A (ASAHI GLASS CO LTD) 15/11/1989 is directed to a process for preparing an aqueous dispersion, which comprises subjecting a monomer to emulsion polymerization in an aqueous medium in the presence of a fluorine-containing copolymer comprising units derived from a fluoroolefin, and units having a hydrophilic side chain having a group which maybe: (i) a carboxylic acid group or a carboxylate group of the formula —COOM, (ii) a sulfonic acid group or a sulfonate group of the formula —SO₃M and (iii) a phosphonic acid group or a phosphonate group of the formula —PO₃M (wherein M is hydrogen, an alkali metal, a quaternary ammonium group, or a quaternary phosphonium group), and (iv) an amido group, and having a number average molecular weight at a level of from 1000 to 500000, particularly from 3000 to 400000. The monomer being polymerised is a fluoroolefin having from 2 to 4 carbon atoms such as hexafluoropropylene, pentafluoropropylene, tetrafluoroethylene, chlorotrifluoroethylene, trifluoroethylene or vinylidenefluoride, and a vinyl compound, an allyl compound, a fluorinated vinyl compound or a fluorinated allyl compound are preferred, since their polymerization gives rise to an aqueous dispersion capable of providing a coating layer having excellent weather resistance.

WO 2012/082707 A1 (3M INNOVATIVE PROPERTIES COMPANY) discloses microemulsions obtained by mixing water, at least one ethylenically unsaturated fluoromonomer, and at least one oligomeric fluorosulfinic compound and/or at least one ethylenically unsaturated, polymerizable monomeric fluorosulfinic compounds and their use for polymerization of the at least one ethylenically unsaturated fluoromonomer. The oligomeric and the polymerisable monomeric fluorosulfinic compounds have low molecular weights and are characterised by the presence of sulfinic/sulfinate functional groups —SO₂M in which M is a cation.

WO 2018/167190 A1 (SOLVAY SPECIALTY POLYMERS ITALY SpA) 28/09/2018 discloses a method for making a fluoropolymer comprising emulsion polymerizing one or more than one fluorinated monomer in an aqueous medium in the presence of at least one radical initiator and at least one polyfunctional dispersant:
comprising a backbone chain comprising recurring units derived from one or more ethylenically unsaturated monomers,
having a molecular weight and distribution thereof such that said dispersant is substantially free from fractions having molecular weight of less than 3000,
comprising a plurality of ionic groups selected from the group consisting of —SO₃Xₐ, —PO₃Xₐ and —COOXₐ, whereas Xₐ is H, an ammonium group or a monovalent metal, in an amount of at least 1.75 meq/g, with respect to the weight of dispersant, wherein the said dispersant is used in an amount of 0.01% by weight and 5.00% by weight, based on the total weight of the aqueous medium. WO 2018/167190 A1 discloses in particular the preparation of PTFE in the presence of a dispersant (D) comprising —SO₃Xₐ ionic groups.

It has been found that the use of certain polyfunctional dispersants disclosed in WO 2018/167190 A1, can be advantageously used in processes for the aqueous emulsion polymerization of monomers comprising hydrolysable groups to provide dispersions of polymers comprising hydrolysable groups free of surfactants.

### DISCLOSURE OF INVENTION

A first object of the invention is a method for making a fluoropolymer comprising a plurality of hydrolysable groups [polymer (P)], said method comprising emulsion polymerising in an aqueous medium:
tetrafluoroethylene, and
at least one ethylenically unsaturated fluorinated monomer comprising
at least one hydrolysable group,
   in the presence of at least one radical initiator and at least one polyfunctional dispersant [dispersant (D)], said dispersant (D):
having a weight average molecular weight (M_{w}) of at least 15000 and at most 800000,
comprising a backbone chain comprising recurring units deriving from one or more ethylenically unsaturated monomers, and
comprising a plurality of ionic groups selected from the group consisting of —SO₃Xₐ and —COOXₐ, wherein Xₐ is H, an ammonium group or a monovalent metal.

The Applicant has surprisingly found that dispersant (D), thanks to the presence of ionic groups as pendant groups in the fluorinated chain, despite its high molecular weight, possesses sufficient surface active effect and dispersing ability for ensuring efficient stabilization of the fluoropolymer in the aqueous polymerization environment.

Advantageously, dispersant (D) has a molecular weight and a molecular weight distribution such that it is substantially free from fractions having molecular weight of less than 3000.

The ionic groups in dispersant (D) are in an amount of at least 1.00 meq/g, with respect to the weight of dispersant (D).

The hydrolysable groups in polymer (P) are preferably selected from —SO₂X and —COOZ, wherein X is a halogen atom and Z is a C1-C4 alkoxy group.

Dispersant (D) is used in an amount from 0.01 wt % to 5.00 wt %, based on the total weight of the aqueous medium.

In an advantageous embodiment of the invention, the ionic groups in dispersant (D) are obtainable from the hydrolysable groups of polymer (P) which is the product of the emulsion polymerisation process. In this embodiment, at the end of the polymerization process polymer (P) does not require any purification step to remove the residues of dispersant (D). Indeed the presence of dispersant (D) will not have any detrimental effect of the properties of polymer (P) thanks to the similar chemical nature.

In an even more advantageous embodiment of the invention, dispersant (D) has the same monomer composition as polymer (P) being obtained at the end of the process, the sole difference being the presence of ionic groups —SO₃Xₐ and —COOXₐ in place of hydrolysable groups —SO₂X and —COOZ, as defined above.

### Definitions

The expression “fluorinated monomer” is hereby intended to denote an ethylenically unsaturated monomer comprising at least one fluorine atom.

The expression “essentially consisting of” when used in respect of a polymer composition, including dispersant (D), is meant to indicate that said polymer contains no more than 1 mol %, with respect to total moles of recurring units of end-groups, impurities, defects and other spurious recurring units in addition to the listed recurring units.

Polymer (P)

The method of the invention comprises emulsion polymerizing in an aqueous medium tetrafluoroethylene and at least one ethylenically unsaturated fluorinated monomer comprising at least one hydrolysable group. The hydrolysable group is selected from the group consisting of —SO₂X and —COOZ, wherein X is a halogen atom and Z is a C1-C4 alkoxy group.

Polymer (P) preferably comprises recurring units deriving from at least one ethylenically unsaturated fluorinated monomer comprising at least one hydrolysable group —SO₂X wherein X is a halogen, hereinafter referred to as [monomer (A)].

Non limiting examples of suitable monomers (A) are selected from the group consisting of:
sulfonyl halide fluoroolefins of formula: CF₂=CF(CF₂)ₚSO₂X, with X being halogen, preferably F or Cl, more preferably F, wherein p is an integer between 0 and 10, preferably between 1 and 6, more preferably p is equal to 1, 2 or 3;
sulfonyl halide fluorovinylethers of formula: CF₂=CF—O—(CF₂)ₘSO₂X, with X being halogen, preferably F or Cl, more preferably F, wherein m is an integer between 1 and 10, preferably between 1 and 6, more preferably between 2 and 4, even more preferably m equals 2;
sulfonyl halide fluoroalkoxyvinylethers of formula: CF₂=CF—(OCF₂CF(R_{F1}))_{w}—O—CF₂(CF(R_{F2}))_{y}SO₂X with X being halogen, preferably F or Cl, more preferably F, wherein w is an integer between 0 and 2, R_{F1} and R_{F2}, equal or different from each other, are independently F, Cl or a C₁-C₁₀ fluoroalkyl group, optionally substituted with one or more ether oxygen atoms, y is an integer between 0 and 6; preferably w is 1, R_{F1} is —CF₃, y is 1 and R_{F2} is F;
sulfonyl halide aromatic fluoroolefins of formula CF₂=CF—Ar—SO₂X with X being halogen, preferably F or Cl, more preferably F, wherein Ar is a C₅-C₁₅ aromatic or heteroaromatic group.

Preferably monomer (A) is selected from the group of the sulfonyl fluoride fluorovinylethers of formula CF₂=CF—O—(CF₂)ₘ—SO₂F, wherein m is an integer between 1 and 6, preferably between 2 and 4.

More preferably monomer (A) is CF₂=CFOCF₂CF₂—SO₂F (perfluoro-5-sulfonylfluoride-3-oxa-1-pentene).

Additional fluorinated monomers may be present during the polymerization process and incorporated in polymer (P).

Non limiting examples of suitable ethylenically unsaturated fluorinated monomers are:
C₂-C₈ perfluoroolefins, such as hexafluoropropylene, perfluoroisobutylene;
C₂-C₈ hydrogen-containing fluoroolefins, such as trifluoroethylene, vinylidene fluoride, vinyl fluoride, pentafluoropropylene, and hexafluoroisobutylene;
C₂-C₈ chloro- and/or bromo- and/or iodo-containing fluoroolefins, such as chlorotrifluoroethylene and bromotrifluoroethylene;
fluoroalkylvinylethers of formula CF₂=CFOR_{f1}, wherein R_{f1} is a C₁-C₆ fluoroalkyl, e.g. —CF₃, —C₂F₅, —C₃F₇;
fluorooxyalkylvinylethers of formula CF₂=CFOXo, wherein Xo is a C₁-C₁₂ fluorooxyalkyl group comprising one or more than one ethereal oxygen atom, including notably fluoromethoxyalkylvinylethers of formula CF₂=CFOCF₂OR_{f2}, with R_{f2} being a C₁-C₃ fluoro(oxy)alkyl group, such as —CF₂CF₃, —CF₂CF₂—O—CF₃ and —CF₃
fluorodioxoles, of formula:

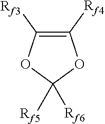

wherein each of R_{f3}, R_{f4}, R_{f5}, R_{f6}, equal or different each other, is independently a fluorine atom, a C₁-C₆ fluoro(halo)fluoroalkyl, optionally comprising one or more oxygen atom, e.g. —CF₃, —C₂F₅, —C₃F₇, —OCF₃, —OCF₂CF₂OCF_{3.}

Preferred fluorinated monomers for use in the method of the present invention, in addition to tetrafluoroethylene, include chlorotrifluoroethylene, hexafluoropropylene, vinyl fluoride, vinylidene fluoride.

Polymer (P) is preferably selected from polymers comprising or consisting essentially of:
50 to 99 mol %, preferably 50 to 98 mol %, even 5 to 95 mol %, with respect to total moles of polymer (P), of recurring units deriving from tetrafluoroethylene (TFE);
1 to 50 mol %, preferably 2 to 50 mol %, even 5 to 50 mol %, with respect to total moles of polymer (P), of recurring units deriving from at least one monomer selected from the group consisting of:
(j) sulfonyl halide fluorovinylethers of formula: CF₂=CF—O—(CF₂)ₘSO₂X, with X being halogen, preferably F or Cl, more preferably F, wherein m is an integer between 1 and 10, preferably between 1 and 6, more preferably between 2 and 4, even more preferably m equals 2; (jj) sulfonyl halide fluoroalkoxyvinylethers of formula: CF₂=CF—(OCF₂CF(R_{F1}))_{W}—O—CF₂(CF(R_{F2}))_{y}SO₂X with X being halogen, preferably F or Cl, more preferably F, wherein w is an integer between 0 and 2, R_{F1} and R_{F2}, equal or different from each other, are independently F, Cl or a C₁-C₁₀ fluoroalkyl group, optionally substituted with one or more ether oxygen atoms, y is an integer between 0 and 6; preferably w is 1, R_{F1} is —CF₃, y is 1 and R_{F2} is F; and (jjj) mixtures thereof; and
0 to 45 mol %, preferably 0 to 40 mol %, even 0 to 25 mol %, with respect to total moles of polymer (P), of recurring units deriving from at least one hydrogenated and/or fluorinated monomer different from TFE, preferably a perfluorinated monomer, generally selected from the group consisting of hexafluoropropylene, perfluoroalkylvinylethers of formula CF₂=CFOR′_{f1}, wherein R′_{f1} is a C₁-C₆ perfluoroalkyl, e.g. —CF₃, —C₂F₅, —C₃F₇; perfluoro-oxyalkylvinylethers of formula CF₂=CFOR′ₒ₁, wherein R′ₒ₁ is a C₂-C₁₂ perfluoro-oxyalkyl having one or more ether groups, including e.g. perfluoroalkyl-methoxy-vinylethers of formula CF₂=CFOCF₂OR′_{f2} in which R′_{f2} is a C₁-C₆ perfluoroalkyl, e.g. —CF₃, —C₂F₅, —C₃F₇ or a C₁-C₆ perfluorooxyalkyl having one or more ether groups, like —C₂F₅—O—CF₃; fluorodioxoles, of formula:

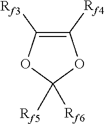

wherein each of R_{f3}, R_{f4}, R_{f5}, R_{f6}, equal or different each other, is independently a fluorine atom, a C₁-C₆ fluoro(halo)fluoroalkyl, optionally comprising one or more oxygen atom, e.g. —CF₃, —C₂F₅, —C₃F₇, —OCF₃, —OCF₂CF₂OCF₃, preferably —OCF₃.

According to certain embodiments, polymer (P) comprises, consists essentially of, consists of:
(1) from 50 to 95 mol %, preferably from 55 to 93 mol % of recurring units deriving from TFE;
(2) from 5 to 50 mol %, preferably from 7 to 45 mol % of recurring units deriving from —SO₂X groups-containing monomer (A), as above detailed;
(3) from 0 to 25 mol %, preferably from 0 to 20 mol % of recurring units deriving from fluorinated monomer(s) different from TFE, as above detailed.

Polymer (P) generally possess a weight average molecular weight (M_{w}), as measured by GPC with respect to polystyrene standards, using dimethylacetamide as eluent, of at least 50000, preferably of at least 85000 more preferably of at least 100000.

The weight average molecular weight (M_{w}), as measured by GPC with respect to polystyrene standards, using dimethylacetamide as eluent, of polymer (P) is generally of at most 700000, preferably at most 600000, more preferably at most 500000. Suitable ranges for most applications of polymer (P) are for instance from 150000 to 600000, preferably from 180000 to 500000.

Preferably polymer (P) has a number average molecular weight of at least 50000, preferably of at least 90000 and/or advantageously of at most 500000, preferably of at most 450000, as measured by GPC with respect to polystyrene standards, using dimethylacetamide as eluent. The GPC method is detailed in the experimental section.

### Dispersant (D)

Polyfunctional dispersant (D) comprises a backbone chain comprising recurring units deriving from one or more ethylenically unsaturated monomers, and a plurality of ionic groups selected from the group consisting of —SO₃Xₐ and —COOXₐ, wherein Xₐ is H, an ammonium group or a monovalent metal. Dispersant (D) does not contain unsaturated carbon-carbon bonds.

Dispersant (D) is used in an amount from 0.01 wt % to 5.00 wt %, based on the total weight of the aqueous medium.

The amount of dispersant (D) in the emulsion polymerization process is of at least 0.05 wt %, preferably of at least 0.10 wt % and advantageously at most 4.00 wt %, preferably at most 3.50 wt %, even more preferably at most 3.00 wt % with respect to the total weight of the aqueous medium. A practical range is between 0.10 wt % and 2.75 wt %, preferably between 0.25 wt % and 2.00 wt %, even between 0.50 wt % and 1.75 wt % with respect to the total weight of the aqueous medium. In certain embodiments dispersant (D) is present in an amount between 0.25 wt % and 1.50 wt % with respect to the total weight of the aqueous medium.

While the polymerization is generally initiated in the presence of dispersant (D), it is not excluded to add further dispersant (D) during the polymerization, although such will generally not be necessary.

Dispersant (D) has a weight average molecular weight (M_{w}), as measured by GPC with respect to polystyrene standards, using dimethylacetamide as eluent, of at least 15000. The GPC method is detailed in the experimental section.

Upper boundaries for the weight average molecular weight (M_{w}), as measured by GPC with respect to polystyrene standards, using dimethylacetamide as eluent, of dispersant (D) are not particularly critical, provided the dispersant (D) possesses an amount of ionic groups per weight of dispersant which enable it to have adequate dispersability.

It is nonetheless understood that a practical range for the weight average molecular weight of dispersant (D) is generally of at most 800000, at most 600000, preferably at most 500000, more preferably at most 400000.

Preferably dispersant (D) has a weight average molecular weight of at least 20000, preferably of at least 25000, advantageously of at least 50000, at least 100000 or even at least 150000.

Particularly good results have been obtained with dispersants having a weight average molecular weight of from 50000 to 400000, even 150000 to 400000.

Dispersant (D) may advantageously have a number average molecular weight (Mn) of 7000 to 500000, preferably from 25000 to 400000, even from 50000 to 250000.

Advantageously, dispersant (D) is a polymer having a molecular weight and a molecular weight distribution such that dispersant (D) is substantially free from fractions having molecular weight of less than 3000.

Determination of substantial absence of fractions having molecular weight of less than 3000 can be done using GPC technique, with respect to polystyrene standards, using dimethylacetamide as eluent. The GPC method is detailed in the experimental section.

The expression “substantially free” in connection with dispersant (D) and fractions having molecular weight of less than 3000 is intended to mean that said fractions are present in an amount of at most 0.03 wt %, preferably at most 0.01 wt % and more preferably they are not detectable via GPC technique, as detailed above.

Dispersant (D) comprises a plurality of ionic groups selected from the group consisting of —SO₃Xₐ and —COOXₐ, wherein Xₐ is H, an ammonium group or a monovalent metal. The monovalent metal is typically selected from the group of the alkali metals, preferably it is sodium or potassium.

Preferably dispersant (D) comprises a plurality of ionic groups selected from the group consisting of —SO₃Xₐ wherein Xₐ is selected from H, an ammonium group or a monovalent metal.

The amount of said ionic groups in dispersant (D) is generally of at least 1.00 meq/g, at least 1.10 meq/g, preferably at least 1.20 meq/g, more preferably at least 1.30 meq/g, with respect to the weight of dispersant (D). Dispersants (D) which possess an amount of ionic group of less than 1.00 meq/g are believed to lack a sufficient polarity for solubilizing in the water phase and producing a stabilizing/surfactant-like effect. There's no substantial limitation as per the maximum amount of the said ionic groups in dispersant (D). It is generally understood that the said ionic groups are generally present in an amount of at most 2.50 meq/g, preferably at most 2.20 meq/g, more preferably at most 2.00 meq/g.

Dispersant (D) comprises said ionic groups as pendant groups covalently bound to recurring units deriving from an ethylenically unsaturated functional monomer [monomer (X)].

Dispersant (D) may consist essentially of recurring units deriving from one or more than one monomer (X) or it can be a copolymer comprising recurring units deriving from one or more than one monomer (X) and recurring units deriving from one or more than one additional monomer different from monomer (X).

Generally, monomer (X) is a fluorinated monomer; one or more than one additional monomer different from monomer (X) may be a fluorinated monomer.

According to certain embodiments of the invention, dispersant (D) is polymer comprising a plurality of —SO₃Xₐ groups.

Dispersant (D) may consist essentially of recurring units deriving from one or more than one ethylenically unsaturated monomer comprising a —SO₃Xₐ group. Alternatively, dispersant (D) may comprise recurring units deriving from one or more than one monomer comprising a —SO₃Xₐ group and recurring units deriving from one or more than one monomer which does not contain a —SO₃Xₐ group.

The expression “recurring units deriving from” in connection with a monomer comprising a —SO₃Xₐ group is intended to encompass both i) recurring units as derived/directly obtained from polymerizing said monomer and ii) recurring units derived/obtained from polymerizing a monomer comprising a functional group precursor to a —SO₃Xₐ group followed by modification and/or post-treatment of the polymer, e.g. by hydrolysis. In other terms a dispersant comprising recurring units deriving from one or more than one monomer comprising a —SO₃Xₐ group, may be obtained by polymerizing monomers comprising —SO₂X groups followed by hydrolysis of the same. For the avoidance of doubt dispersant (D) contains ionic —SO₃Xₐ groups.

Suitable dispersants (D) comprising a plurality of —SO₃Xₐ group are polymers comprising recurring units deriving from:
at least one ethylenically unsaturated fluorinated monomer containing at least one —SO₂X group, with X being a halogen (eg. F) or —OXₐ, with Xₐ is H, an ammonium group or a monovalent metal; and
recurring units deriving from at least one ethylenically unsaturated fluorinated monomer free from —SO₂X group, [monomer (B)]hereinafter.

Ethylenically unsaturated fluorinated monomers containing at least one —SO₂X group suitable for the preparation of dispersant (D) can be selected from the list consisting of monomer (A) detailed above, wherein X is a halogen (eg. F) or —OXₐ, with Xₐ═H, an ammonium group or a monovalent metal.

The phrase “at least one monomer” is used herein with reference to monomers of both type (A) and (B) to indicate that one or more than one monomer of each type can be present in the dispersant (D). Hereinafter the term monomer will be used to refer to both one and more than one monomer of a given type.

Non limiting examples of suitable ethylenically unsaturated fluorinated monomers of type (B) are:
C₂-C₈ perfluoroolefins, such as tetrafluoroethylene, hexafluoropropylene, perfluoroisobutylene;
C₂-C₈ hydrogen-containing fluoroolefins, such as trifluoroethylene, vinylidene fluoride, vinyl fluoride, pentafluoropropylene, and hexafluoroisobutylene;
C₂-C₈ chloro- and/or bromo- and/or iodo-containing fluoroolefins, such as chlorotrifluoroethylene and bromotrifluoroethylene;
fluoroalkylvinylethers of formula CF₂=CFOR_{f1}, wherein R_{f1} is a C₁-C₆ fluoroalkyl, e.g. —CF₃, —C₂F₅, —C₃F₇;
fluorooxyalkylvinylethers of formula CF₂=CFOXo, wherein Xo is a C₁-C₁₂ fluorooxyalkyl group comprising one or more than one ethereal oxygen atom, including notably fluoromethoxyalkylvinylethers of formula CF₂=CFOCF₂OR_{f2}, with R_{f2} being a C₁-C₃ fluoro(oxy)alkyl group, such as —CF₂CF₃, —CF₂CF₂—O—CF₃ and —CF₃
fluorodioxoles, of formula:

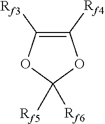

wherein each of R_{f3}, R_{f4}, R_{f5}, R_{f6}, equal or different each other, is independently a fluorine atom, a C₁-C₆ fluoro(halo)fluoroalkyl, optionally comprising one or more oxygen atom, e.g. —CF₃, —C₂F₅, —C₃F₇, —OCF₃, —OCF₂CF₂OCF₃.

Preferably monomer (B) is selected among:
C₂-C₈ perfluoroolefins selected from tetrafluoroethylene and/or hexafluoropropylene;
C₂-C₈ hydrogen-containing fluoroolefins, selected from trifluoroethylene, vinylidene fluoride, and vinyl fluoride; and
mixtures thereof.

More preferably monomer (B) is tetrafluoroethylene.

In a preferred embodiment dispersant (D) is a fluorinated polymer comprising a plurality of —SO₃Xₐ functional groups, and consisting essentially of, consisting of, recurring units deriving from at least one ethylenically unsaturated fluorinated monomer containing at least one —SO₃Xₐ group and from at least one ethylenically unsaturated fluorinated monomer (B).

According to certain embodiments, at least one monomer (B) of the dispersant (D) is TFE.

Preferred dispersants (D) are selected from the group consisting of polymers comprising, essentially consisting of:
50 to 99 mol %, preferably 50 to 98 mol %, even 50 to 95 mol %, with respect to total moles of dispersant (D), of recurring units deriving from tetrafluoroethylene (TFE);
1 to 50 mol %, preferably 2 to 50 mol %, even 5 to 50 mol %, with respect to total moles of dispersant (D), of recurring units deriving from at least one monomer selected from the group consisting of:
(j) sulfonyl halide fluorovinylethers of formula: CF₂=CF—O—(CF₂)ₘSO₂X, with X being OXₐ, with Xₐ as above detailed or X is halogen, preferably F or Cl, more preferably F, wherein m is an integer between 1 and 10, preferably between 1 and 6, more preferably between 2 and 4, even more preferably m equals 2; (jj) sulfonyl halide fluoroalkoxyvinylethers of formula: CF₂=CF—(OCF₂CF(R_{F1}))_{w}—O—CF₂(CF(R_{F2}))_{y}SO₂X with X being OXₐ, with Xₐ as above detailed or X is halogen, preferably F or Cl, more preferably F, wherein w is an integer between 0 and 2, R_{F1} and R_{F2}, equal or different from each other, are independently F, Cl or a C₁-C₁₀ fluoroalkyl group, optionally substituted with one or more ether oxygen atoms, y is an integer between 0 and 6; preferably w is 1, R_{F1} is —CF₃, y is 1 and R_{F2} is F; and
(jjj) mixtures thereof; and
0 to 45 mol %, preferably 0 to 40 mol %, even 0 to 25 mol %, with respect to total moles of dispersant (D), of recurring units deriving from at least one hydrogenated and/or fluorinated monomer different from TFE, preferably a perfluorinated monomer, generally selected from the group consisting of hexafluoropropylene, perfluoroalkylvinylethers of formula CF₂=CFOR′f1, wherein R′f1 is a C₁-C₆ perfluoroalkyl, e.g. —CF₃, —C₂F₅, —C₃F₇; perfluoro-oxyalkylvinylethers of formula CF₂=CFOR′o1, wherein R′o1 is a C₂-C₁₂ perfluoro-oxyalkyl having one or more ether groups, including e.g. perfluoroalkyl-methoxy-vinylethers of formula CF₂=CFOCF₂OR′f2 in which R′f2 is a C₁-C₆ perfluoroalkyl, e.g. —CF₃, —C₂F₅, —C₃F₇ or a C₁-C₆ perfluorooxyalkyl having one or more ether groups, like —C₂F₅—O—CF₃.

According to certain embodiments, the preferred dispersant (D) comprises, essentially consists of:
from 50 to 95 mol %, preferably from 55 to 93 mol % of recurring units deriving from TFE;
from 5 to 50 mol %, preferably from 7 to 45 mol % of recurring units deriving from —SO₂X groups-containing monomer(s), monomer (A);
from 0 to 25 mol %, preferably from 0 to 20 mol % of recurring units deriving from fluorinated monomer(s) different from TFE, monomer (B).

In an advantageous embodiment of the invention both polymer (P) and dispersant (D) comprise:
from 50 to 95 mol %, preferably from 55 to 93 mol % of recurring units deriving from TFE;
from 5 to 50 mol %, preferably from 7 to 45 mol % of recurring units deriving from —SO₂X groups-containing monomer(s), monomer (A);
from 0 to 25 mol %, preferably from 0 to 20 mol % of recurring units deriving from fluorinated monomer(s) different from TFE, monomer (B).

In certain embodiments of the invention, dispersant (D) has the same molar composition as polymer (P).

In a very advantageous embodiment of the invention, polymer (P), after hydrolysis of the hydrolysable groups, is used as dispersant in a further polymerization process.

Hence the method of the invention comprises the step of: recovering polymer (P), hydrolysing the hydrolysable —SO₂X groups to obtain —SO₃Xₐ groups to obtain dispersant (D).

The inventive method thus comprises the step of preparing dispersant (D) by emulsion polymerising in an aqueous medium:
tetrafluoroethylene, and
at least one ethylenically unsaturated fluorinated monomer comprising at least one hydrolysable group selected from —SO₂X and —COOZ, wherein X is a halogen atom and Z is a C1-C4 alkoxy group, in the presence of at least one radical initiator and a dispersant [dispersant (Dx)] to obtain a polymer comprising a plurality of hydrolysable groups; hydrolysing the hydrolysable groups to obtain corresponding ionic groups-SO₃Xₐ and —COOXₐ, wherein Xₐ is H, an ammonium group or a monovalent metal.

Dispersant (Dx) is present in an amount from 0.01 wt % to 5.00 wt %, based on the total weight of the aqueous medium.

Dispersant (D) may be any dispersant know in the art for preparing fluoropolymers. Advantageously, dispersant (Dx) is dispersant (D).

Hence, in an advantageous embodiment, the inventive method comprises the step of preparing dispersant (D) by emulsion polymerising in an aqueous medium:
tetrafluoroethylene, and
at least one ethylenically unsaturated fluorinated monomer comprising
at least one hydrolysable group selected from —SO₂X and —COOZ,
wherein X is a halogen atom and Z is a C₁-C₄ alkoxy group, in the presence of at least one radical initiator and a dispersant (Dx) having a weight average molecular weight from 15000 to 800000, comprising a backbone chain comprising recurring units deriving from one or more ethylenically unsaturated monomers, and comprising a plurality of ionic groups selected from the group consisting of —SO₃Xₐ and —COOXₐ, wherein Xₐ is H, an ammonium group or a monovalent metal;
to obtain a polymer comprising a plurality of hydrolysable groups; hydrolysing the hydrolysable groups to obtain corresponding ionic groups-SO₃Xₐ and —COOXₐ, wherein Xₐ is H, an ammonium group or a monovalent metal.

Dispersant (Dx) has a molecular weight and a molecular weight distribution such that it is substantially free from fractions having molecular weight of less than 3000, as measured by GPC with respect to polystyrene standards, using dimethylacetamide as eluent. The GPC method is detailed in the experimental section.

The ionic groups in dispersant (Dx) are in an amount of at least 1.00 meq/g, with respect to the weight of dispersant (Dx).

Dispersant (Dx) is present in the emulsion polymerisation medium in an amount from 0.01 wt % to 5.00 wt %, based on the total weight of the aqueous medium.

Dispersant (Dx) has the same monomer composition, average molecular weight and molecular weight distribution as dispersant (D) obtained at the end of the process.

Dispersant (D) as well as polymer (P) may be prepared by any polymerization process known in the art. Suitable processes for the preparation of such polymers are for instance those described in U.S. Pat. No. 4,940,525 (THE DOW CHEMICAL COMPANY) 10/07/1990, EP 1323751 A (SOLVAY SOLEXIS SPA) 2/07/2003, EP 1172382 A (SOLVAY SOLEXIS SPA) 16/11/2002.

The aqueous emulsion polymerization may be carried out at a temperature between 10° C. to 150° C., preferably 20° C. to 130° C. and the pressure is typically between 2 and 60 bar, in particular 5 to 45 bar.

The reaction temperature may be varied during the polymerization e.g. for influencing the molecular weight distribution, i.e., to obtain a broad molecular weight distribution or to obtain a bimodal or multimodal molecular weight distribution.

The pH of the polymerization media may be in the range of pH 1-10, preferably 2-10.

As said, the method of the invention is carried out in an aqueous medium in the presence of at least one radical initiator, i.e. any of the initiators known for initiating a free radical polymerization of ethylenically unsaturated monomers. Suitable radical initiators include notably peroxides and azo compounds and redox based initiators. Specific examples of peroxide initiators include, hydrogen peroxide, sodium or barium peroxide, diacylperoxides such as diacetylperoxide, disuccinyl peroxide, dipropionylperoxide, dibutyrylperoxide, dibenzoylperoxide, di-ter-butyl-peroxide, benzoylacetylperoxide, diglutaric acid peroxide and dilaurylperoxide, and further per-acids and salts thereof such as e.g. ammonium, sodium or potassium salts. Examples of per-acids include peracetic acid. Esters of the peracid can be used as well and examples thereof include tert.-butylperoxyacetate and tert.-butylperoxypivalate. Examples of inorganic initiators include for example ammonium-, alkali- or earth alkali-salts of persulfates, permanganic or manganic acid or manganic acids. A persulfate initiator, e.g. ammonium persulfate (APS), can be used on its own or may be used in combination with a reducing agent. Suitable reducing agents include bisulfites such as for example ammonium bisulfite or sodium metabisulfite, thiosulfates such as for example ammonium, potassium or sodium thiosulfate, hydrazines, azodicarboxylates and azodicarboxyldiamide (ADA). Further reducing agents that may be used include hydroxymethane sodium sulfinate (Rongalite) or fluoroalkyl sulfinates such as those disclosed in U.S. Pat. No. 5,285,002. The reducing agent typically reduces the half-life time of the persulfate initiator. Additionally, a metal salt catalyst such as for example copper, iron or silver salts may be added.

The amount of initiator may be between 0.01% by weight (based on the fluoropolymer to be produced) and 1.00% by weight. Still, the amount of initiator is preferably between 0.05 and 0.50% by weight and more preferably between 0.05 and 0.30% by weight, based on the fluoropolymer to be produced.

The aqueous emulsion polymerization can be carried out in the presence of other materials, such as notably paraffin waxes, buffers and, if desired, complex-formers or chain-transfer agents.

Examples of chain transfer agents that can be used include dimethyl ether, methyl t-butyl ether, alkanes having 1 to 5 carbon atoms such as ethane, propane and n-pentane, halogenated hydrocarbons such as CCl₄, CHCl₃ and CH₂C₁₂ and hydrofluorocarbon compounds such as CH₂F—CF₃ (R134a). Additionally esters like ethylacetate, malonic esters can be effective as chain transfer agent in the method of the invention.

Further, the aqueous emulsion polymerization of the method of the invention can be carried out in the presence of certain fluorinated fluids deprived of ionic groups, typically enabling formation of nanosized droplets (average size of less than 50 nm, preferably of less than 30 nm), and advantageously stabilized in aqueous dispersion by the presence of the dispersant (D).

Should the method of the invention be carried out in the presence of a fluorinated fluid, as above detailed, it may be preferable to first homogenously mix the dispersant (D) and said fluid in an aqueous medium, and then feeding the so obtained aqueous mixture of the dispersant (D) and said fluid in the polymerization medium. This technique is particularly advantageous as this pre-mix can advantageously enable manufacture of an emulsion of said fluid in an aqueous phase comprising the dispersant (D), wherein this emulsion comprises dispersed droplets of said fluid having an average size of preferably less than 50 nm, more preferably of less than 40 nm, even more preferably of less than 30 nm.

Fluids which can be used according to this embodiment are preferably (per)fluoropolyethers comprising recurring units (R1), said recurring units comprising at least one ether linkage in the main chain and at least one fluorine atom (fluoropolyoxyalkene chain). Preferably the recurring units R1 of the (per)fluoropolyether are selected from the group consisting of:
(I) —CFX—O—, wherein X is —F or —CF₃; and
(II) —CF₂—CFX—O—, wherein X is —F or —CF₃; and
(III) —CF₂—CF₂—CF₂—O—; and
(IV) —CF₂—CF₂—CF₂—CF₂—O—; and
(V) —(CF₂)ⱼ—CFZ—O—wherein j is an integer chosen from 0 and 1 and Z is a fluoropolyoxyalkene chain comprising from 1 to 10 recurring units chosen among the classes (I) to (IV) here above; and mixtures thereof.

Should the (per)fluoropolyether comprise recurring units R1 of different types, advantageously said recurring units are randomly distributed along the fluoropolyoxyalkene chain.

Preferably the (per)fluoropolyether is a compound complying with formula (I-p) here below:

T₁-(CFX)ₚ—O—R_{f}—(CFX)ₚ′-T₂ (I-p)

wherein:
each of X is independently F or CF₃;
p and p′, equal or different each other, are integers from 0 to 3;
R_{f} is a fluoropolyoxyalkene chain comprising repeating units R^{o}, said repeating units being chosen among the group consisting of:
(i) —CFXO—, wherein X is F or CF₃,
(ii) —CF₂CFXO—, wherein X is F or CF₃,
(iii) —CF₂CF₂CF₂O—,
(iv) —CF₂CF₂CF₂CF₂O—,
(v) —(CF₂)ⱼ—CFZ—O—wherein j is an integer chosen from 0 and 1 and Z is a group of general formula —OR_{f}′T₃, wherein R_{f}′ is a fluoropolyoxyalkene chain comprising a number of repeating units from 0 to 10, said recurring units being chosen among the followings: —CFXO—, —CF₂CFXO—, —CF₂CF₂CF₂O—, —CF₂CF₂CF₂CF₂O—, with each of each of X being independently F or CF₃; and T₃ is a C₁-C₃ perfluoroalkyl group, and mixtures thereof;
T₁ and T₂, the same or different each other, are H, halogen atoms, C₁ —C₃ fluoroalkyl groups, optionally comprising one or more H or halogen atoms different from fluorine.

Generally speaking, the method of the invention is carried out in the substantial absence of fluorinated emulsifiers having a molecular weight of less than 1000.

The expression “substantial absence” when used in connection to the fluorinated emulsifiers means that no surfactant is purposely added to the polymerization. While impurities possibly qualifying as fluorinated surfactants with a molecular weight of less than 1000 might be tolerated, their amount is generally below of detection limit of standard analytical techniques (<1 ppm, with respect to the aqueous medium).

More generally, the method of the invention is carried out in the substantial absence of fluorinated emulsifiers having a molecular weight of less than 3000.

More specifically, the method of the invention include polymerizing in an aqueous medium which is substantially free from fluorinated emulsifier [surfactant (FS)]of formula:

R_{f§}(X⁻)ⱼ (M⁺)ⱼ

wherein R_{f§} is a C₃ —C₃₀ (per)fluoroalkyl chain, (per)fluoro(poly)oxyalkylenic chain, X⁻is —COO⁻, —PO₃ ⁻or —SO₃⁻, M⁺is selected from H⁺, NH₄⁺, an alkaline metal ion and j can be 1 or 2 can be used.

As non-limitative examples of surfactants (FS), mention may be made of ammonium and/or sodium (per)fluoro(oxy)carboxylates, and/or (per)fluoropolyoxyalkylenes having one or more carboxylic end groups.

Examples of fluorinated surfactants, in particular of (per)fluorooxyalkylenic surfactants, are notably described in US 2007015864 (3M INNOVATIVE PROPERTIES) 8/01/2007, US 2007015865 (3M INNOVATIVE PROPERTIES CO) 18/01/2007, US 2007015866 (3M INNOVATIVE PROPERTIES CO) 18/01/2007, US 2007025902 (3M INNOVATIVE PROPERTIES CO) 1/02/2007.

For instance, the fluorinated emulsifiers [surfactant (FS)]substantially excluded from the method of the invention are notably:
CF₃(CF₂)ₙ₁COOM′, in which n₁ is an integer ranging from 4 to 10, preferably from 5 to 7, and more preferably being equal to 6; M′ represents H, NH₄, Na, Li or K, preferably NH₄;
T(C₃F₆O)ₙ₀(CFXO)ₘ₀CF₂COOM″, in which T represents Cl or a perfluoroalkoxyde group of formula CₖF₂ₖ₊₁ O with k is an integer from 1 to 3, one F atom being optionally substituted by a C₁ atom; n₀ is an integer ranging from 1 to 6; m₀ is an integer ranging from 0 to 6; M″ represents H, NH₄, Na, Li or K; X represents F or CF₃;
F—(CF₂CF₂)ₙ₂—CH₂—CH₂—RO₃M″′, in which R is P or S, preferably S, M″′ represents H, NH₄, Na, Li or K, preferably H; n₂ is an integer ranging from 2 to 5, preferably n₂=3;
A-R_{f}—B bifunctional fluorinated surfactants, in which A and B, equal to or different from each other, are —(O)ₚCFX-COOM*; M* represents H, NH₄, Na, Li or K, preferably M* represents NH₄; X═F or CF₃; p is an integer equal to 0 or 1; R_{f} is a linear or branched perfluoroalkyl chain, or a (per)fluoropolyether chain such that the number average molecular weight of A-R_{f}—B is in the range 300 to 1,000;
R′_{f}—O—(CF₂)ᵣ—O-L-COOM′, wherein R′_{f} is a linear or branched perfluoroalkyl chain, optionally comprising catenary oxygen atoms, M′ is H, NH₄, Na, Li or K, preferably M′ represents NH₄; r is 1 to 3; L is a bivalent fluorinated bridging group, preferably —CF₂CF₂—or —CFX—, X═F or CF₃;
R″_{f}—(OCF₂)ᵤ—O—(CF₂)ᵥ-COOM″, wherein R″_{f} is a linear or branched perfluoroalkyl chain, optionally comprising catenary oxygen atoms, M″ is H, NH₄, Na, Li or K, preferably M″ represents NH₄; u and v are integers from 1 to 3;
R″′_{f}—(O)ₜ-CHQ-L-COOM″′, wherein R″′_{f} is a linear or branched perfluoroalkyl chain, optionally comprising catenary oxygen atoms, Q=F or CF₃, t is 0 or 1, M″′ is H, NH₄, Na, Li or K, preferably M″′ is NH₄; L is a bivalent fluorinated bridging group, preferably —CF₂CF₂—or —CFX—, X═F or CF₃;
cyclic fluorocompound of the following formula (1):

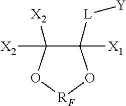

wherein X₁, X₂, X₃, equal or different from each other are independently selected among H, F, and C₁₋₆ (per)fluoroalkyl groups, optionally comprising one or more catenary or non-catenary oxygen atoms; L represents a bond or a divalent group; R_{F} is a divalent fluorinated C₁₋₃ bridging group; Y is a hydrophilic function selected from groups of formulae:

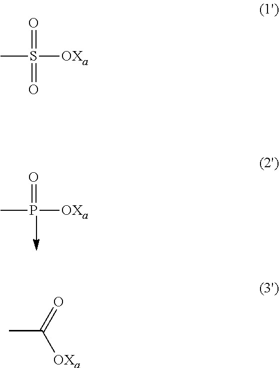

wherein Xₐ is H, a monovalent metal (preferably an alkaline metal) or an ammonium group of formula —N(R′ₙ)₄, wherein R′ₙ, equal or different at each occurrence, represents a hydrogen atom or a C₁₋₆ hydrocarbon group.

The method of the invention typically results in an aqueous dispersion of the fluoropolymer further comprising dispersant (D), as above detailed.

The particle size (volume average diameter) of the fluoropolymer is typically between 40 nm and 400 nm with a typical particle size between 60 nm and about 350 nm being preferred.

The fluoropolymer may be isolated from the dispersion by coagulation or any other suitable technique if a polymer in solid form is desired.

Advantageously, the present invention may further comprise steps for obtaining polymer (P) in its ionic form as a powdery material [material (PP)]composed of a plurality of particles of at least one polymer comprising a plurality of ionic groups selected from the group consisting of —SO₃Xₐ and —COOXₐ, wherein Xₐ is H, an ammonium group or a metal, preferably a monovalent metal, said method comprising:
(1) providing an aqueous dispersion comprising particles of polymer (P) comprising a plurality of hydrolysable groups selected from the group consisting of —SO₂Xₓ and —COOX_{y}, wherein Xₓ is a halogen, in particular F or C₁ and X_{y} is a C1-C4 alkoxy group; and
(2) contacting said aqueous dispersion with a basic hydrolysing agent to at least partially convert said groups —SO₂Xₓ and —COOX_{y} into corresponding groups —SO₃X_{b} and —COOX_{b}, wherein X_{b} is an ammonium group or a monovalent metal, without causing any significant coagulation, so as to obtain an aqueous dispersion of particles of polymer (P) in ionic form; optionally
(3) contacting the dispersion obtained at the end of step (2) with at least one ion exchange resin, so as to at least partially remove residues of basic hydrolysing agent and/or other contaminants; and
(4) spray drying the dispersion obtained at the end of step (2) and optionally step (3) so as to obtain material (PP).

The at least one ion exchange resin in step (3) may be an anion exchange resin, a cation exchange resin or both.

When Xₐ is H, the process comprises a step in which cations X_{b} are exchanged with cations H⁺. The ion exchange may be performed using a cation exchange resin in step (3) or by any other known mean, such as electrodialysis on bipolar membranes.

A process for the recovery of polymer (P) as a powder from an emulsion polymerization latex is described in WO2020/094563A1, the content of which is incorporated herein by reference.

The process for obtaining material (PP) may comprise further steps for the purification on the dispersion. Examples of suitable techniques comprise dialysis, electrodialysis and ultrafiltration. Said further purification step may be performed at any stage, typically between steps (2) and (4). When the optional step (3) is present, the further purification step is performed between steps (2) and (3) or, preferably, between steps (3) and (4).

Additional processes for the recovery of polymer (P) as a powder from the emulsion polymerization latex are for instance disclosed in WO22224105A1, the content of which is incorporated herein by reference.

Depending on the requirements of the application in which the fluoropolymer is to be used, the fluoropolymer in powder form may be post-fluorinated so as to convert any chemically unstable end groups into stable —CF₃ end groups.

For coating applications, an aqueous dispersion of the fluoropolymer is desired and hence the fluoropolymer will not need to be separated or coagulated from the dispersion. To obtain a fluoropolymer dispersion suitable for use in coating applications such as for example in the impregnation of fabrics or other porous supports, it will generally be desired to add further stabilizing surfactants and/or to further increase the fluoropolymer solids. For example, non-ionic stabilizing surfactants may be added to the fluoropolymer dispersion.

The amount of fluoropolymer solids in the dispersion may be increased as needed or desired to an amount between 30 and 70 wt %. Any of the known concentration techniques may be used including ultrafiltration and thermal concentration.

In a preferred embodiment of the invention polymer (P) is used in the preparation of membranes for use in polymer electrolyte membrane fuel cells.

Should the disclosure of any patents, patent applications, and publications which are incorporated herein by reference conflict with the description of the present application to the extent that it may render a term unclear, the present description shall take precedence.

The invention will be now explained in more detail with reference to the following examples, whose purpose is merely illustrative and not intended to limit the scope of the invention.

### Preparative Example 1—Preparation of Dispersant (D-1) by polymerization of tetrafluoroethylene (TFE) and perfluoro-5-sulfonylfluoride-3-oxa-1-pentene (SFVE) and successive hydrolysis

Step 1-Polymerization

In a 5 L autoclave the following reagents were charged:
1.8 L of demineralized water;
533 g of the monomer with formula: CF₂=CF—O—CF₂CF₂—SO₂F (SFVE);
89 g of a 46 wt % aqueous solution of the ammonium salt of the fluorocompound of formula:

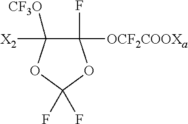

with Xₐ being NH₄.

The autoclave, stirred at 650 rpm, was heated at 58° C. A water based solution with 16 g/L of ammonium persulfate was added in a quantity of 90 mL. The pressure was maintained at a value of 8.5 bar (abs.) by 8.2 bar of feeding tetrafluoroethylene (TFE). After the initial addition of 83 g, SFVE was added portionwise (23 g) each 5 wt % of TFE converted. The reaction was stopped after 200 min by stopping the stirring, cooling the autoclave and reducing the pressure by venting the TFE; a total of 340 g of TFE was fed into the autoclave. Overall, 0.12 grams of surfactant for each gram of converted TFE were used.

The latex thus obtained was degassed for 48 h with air flow to remove monomer's residuals and then coagulated through freeze-thawing. The powder was washed with deionized water (4×1 L) for 30 min and dried in a vent oven at 120° C. overnight.

A copolymer was obtained, said copolymer having an equivalent weight (EW) of 720 g/mol and possessing the following composition: TFE: 81.5 mol %; SFVE: 18.5 mol % as determined by FT-IR measurements. The The polymer had a number average molecular weight (Mn) of 93000 and a weight average molecular weight (M_{w}) of 241000. Substantially no fraction having a molecular weight below 3000 was detected by GPC.

GPC measurements were carried out against polystyrene standards in dimethylacetamide as solvent, using a RI detector. Concentration of the copolymer in the testing solution was 0.5% wt/vol.

Step 2-Stabilization, Hydrolysis and Dissolution in water

250 g of the powder obtained in Step 1 was treated at 70° C. with a mixture of 10 L/h of fluorine and 4 L/h of nitrogen for 3 h end-capping the backbone with —CF₃ functional groups and removing the undesired carboxylic acid groups. The powder was treated under stirring with a 1.5 L solution of NaOH/H₂O (20 wt %) and heated at 80° C. Complete conversion of the originally comprised —SO₂F groups to ionic —SO₃ ⁻ groups was confirmed by solid state NMR. The amount of ionic groups in the polymer was 1.39 meq/g. After 10 h the powder was washed under stirring with deionized water (4×1 L) for 30 min and dissolved in deionized water in a pressurized vessel heated at 250° C.

### Polymerization Example 2: Polymerization of tetrafluoroethylene (TFE) and perfluoro-5-sulfonylfluoride-3-oxa-1-pentene (SFVE) in the presence of dispersant (D-1)

In a 5 L autoclave the following reagents were charged:
1.8 L of demineralized water,
20 g of a 25 wt % aqueous dispersion of dispersant (D-1) (i.e. corresponding to 5 g of dispersant (D-1)), obtained from Preparative Example 1, thus corresponding to a concentration of about 1.05 wt % based on the initial aqueous phase.

The autoclave, stirred at 650 rpm, was heated at 50° C. A water based solution with 16 g/L of sodium persulfate was added in a quantity of 90 mL.

The pressure was maintained at a value of 7.6 bar (abs.) by feeding tetrafluoroethylene (TFE). 82 g of SFVE were fed in the reactor and the pressure of the autoclave was maintained at constant value of 7.8 bar by feeding TFE and feeding SFVE (23 g) each 5% of TFE conversion. After 230 minutes, when a quantity of 340 grams of TFE and 443 g of SFVE were fed, the TFE feeding was stopped. By keeping constant stirring of 650 rpm the autoclave was cooled to ambient temperature the latex was discharged after being kept under air bubbling for 48 hours to strip away residual monomers from the polymerization, and then stored in a plastic tank. No signals of latex coagulation/precipitation were observed.

The latex so produced was characterized by laser light scattering for determining average particle size, which was found to be of 107 nm. The polymer thus obtained had an equivalent weight (EW) of 758 g/mol and a composition, measured through FT-IR, of TFE: 82.7 mol % and SFVE: 17.3 mol %.

1. A method for making a fluoropolymer comprising a plurality of hydrolysable groups, polymer (P), said method comprising emulsion polymerising in an aqueous medium:
tetrafluoroethylene, and
at least one ethylenically unsaturated fluorinated monomer comprising at least one hydrolysable group,
in the presence of at least one radical initiator and at least one polyfunctional dispersant dispersant (D), said dispersant (D):
having a weight average molecular weight (M_{w}), as measured by GPC, of at least 15000 and at most 800000;
comprising a backbone chain comprising recurring units deriving from one or more ethylenically unsaturated monomers; and
comprising a plurality of ionic groups selected from the group consisting of —SO₃Xₐ and —COOXₐ, wherein Xₐ is H, an ammonium group or a monovalent metal.

2. The method of claim 1, wherein dispersant (D) has a molecular weight and a molecular weight distribution such that it is substantially free from fractions having molecular weight of less than 3000 as measured by GPC.

3. The method of claim 1, wherein dispersant (D) has a weight average molecular weight (Mw), as measured by GPC, of from 150000 to 600000.

4. The method of claim 1, wherein the amount of ionic groups in dispersant (D) is at least 1.00 meq/g and/or of at most 2.50 meq/g, with respect to the weight of dispersant (D).

5. The method of claim 1 wherein the amount of dispersant (D) is from 0.01 wt % to 5.00 wt %, based on the total weight of the aqueous medium.

6. The method of claim 1, wherein dispersant (D) is a polymer comprising recurring units deriving from at least one ethylenically unsaturated fluorinated monomer containing at least one group —SO₂X, with X being —OXₐ, wherein Xₐ is H, an ammonium group or a monovalent metal; and recurring units deriving from at least one ethylenically unsaturated fluorinated monomer free from —SO₂X groups.

7. The method of claim 6, wherein the at least one ethylenically unsaturated fluorinated monomer free from —SO₂X groups is tetrafluoroethylene.

8. The method of claim 1 wherein polymer (P) comprises recurring units deriving from at least one ethylenically unsaturated fluorinated monomer comprising at least one hydrolysable group selected from the group consisting of —SO₂X and —COOZ, wherein X is a halogen atom and Z is a C₁-C₄ alkoxy group.

9. The method of claim 1 wherein polymer (P) comprises recurring units deriving from at least one ethylenically unsaturated fluorinated monomer containing at least one —SO₂X group, with X being a halogen.

10. The method of claim 1 wherein polymer (P) and dispersant (D) comprise recurring units deriving from at least one ethylenically unsaturated fluorinated monomer containing at least one —SO₂X group which is selected from the group consisting of:
sulfonyl halide fluoroolefins of formula: CF₂=CF(CF₂)ₚSO₂X; wherein in dispersant (D) X is OXₐ, with Xₐ being H, an ammonium group or a monovalent metal and in polymer (P) X is a halogen wherein p is an integer between 0 and 10;
sulfonyl halide fluorovinylethers of formula: CF₂═CF—O—(CF₂)ₘSO₂X, wherein in dispersant (D) X is OXₐ, with Xₐ being H, an ammonium group or a monovalent metal and in polymer (P) X is a halogen wherein m is an integer between 1 and 10;
sulfonyl halide fluoroalkoxyvinylethers of formula: CF₂═CF—(OCF₂CF(R_{F1}))_{w}—O—CF₂(CF(R_{F2}))_{y}SO₂X
wherein in dispersant (D) X is OXₐ, with Xₐ being H, an ammonium group or a monovalent metal and in polymer (P) X is a halogen wherein w is an integer between 0 and 2, R_{F1} and R_{F2}, equal or different from each other, are independently F, Cl or a C₁-C₁₀ fluoroalkyl group, optionally substituted with one or more ether oxygens, y is an integer between 0 and 6;
sulfonyl halide aromatic fluoroolefins of formula CF₂═CF—Ar—SO₂X wherein in dispersant (D) X is OXₐ, with Xₐ being H, an ammonium group or a monovalent metal and in polymer (P) X is a halogen wherein Ar is a C₅-C₁₅ aromatic or heteroaromatic group.

11. The method of claim 1 wherein polymer (P) and dispersant (D) comprise:
50 to 99 mol %, with respect to total moles of polymer (P) or dispersant (D), of recurring units deriving from tetrafluoroethylene;
1 to 50 mol %, with respect to total moles of polymer (P) or dispersant (D), of recurring units deriving from at least one monomer selected from the group consisting of:
(j) sulfonyl halide fluorovinylethers of formula: CF₂═CF—O—(CF₂)ₘSO₂X, wherein in dispersant (D) X is OXₐ, with Xₐ being H, an ammonium group or a monovalent metal and in polymer (P) X is a halogen wherein m is an integer between 1 and 10;
(jj) sulfonyl halide fluoroalkoxyvinylethers of formula: CF₂═CF—(OCF₂CF(R_{F1}))_{w}—O—CF₂(CF(R_{F2}))_{y}SO₂X with X being OXₐ, wherein in dispersant (D) X is OXₐ, with Xₐ being H, an ammonium group or a monovalent metal and in polymer (P) X is a halogen; wherein w is an integer between 0 and 2, R_{F1} and R_{F2}, equal or different from each other, are independently F, Cl or a C₁-C₁₀ fluoroalkyl group, optionally substituted with one or more ether oxygen atoms, y is an integer between 0 and 6 and
(jjj) mixtures thereof; and
0 to 40 mol %, with respect to total moles of polymer (P) or dispersant (D), of recurring units deriving from at least one hydrogenated and/or fluorinated monomer different from tetrafluoroethylene.

12. The method of claim 1 which comprises the step of preparing dispersant (D) by emulsion polymerising in an aqueous medium: tetrafluoroethylene, and at least one ethylenically unsaturated fluorinated monomer comprising at least one hydrolysable group selected from —SO₂X and —COOZ, wherein X is a halogen atom and Z is a C₁-C₄ alkoxy group, in the presence of at least one radical initiator and a dispersant (Dx) to obtain a polymer comprising a plurality of hydrolysable groups; and hydrolysing the hydrolysable groups to obtain corresponding ionic groups —SO₃Xₐ and —COOXₐ, wherein Xₐ is H, an ammonium group or a monovalent metal.

13. The method of claim 12 in which dispersant (Dx) is present in an amount from 0.01 wt % to 5.00 wt %, based on the total weight of the aqueous medium.

14. The method of claim 12 wherein dispersant (Dx) is dispersant (D).

15. An aqueous dispersion of particles of a fluoropolymer comprising a plurality of hydrolysable groups, polymer (P), said dispersion comprising at least one dispersant (D), said dispersant (D):
comprising a backbone chain comprising recurring units deriving from one or more ethylenically unsaturated monomers,
having a weight average molecular weight (M_{w}) of at least 15000 and at most 800000,
comprising a plurality of ionic groups selected from the group consisting of —SO₃Xₐ and —COOXₐ, wherein Xₐ is H, an ammonium group or a monovalent metal.

16. A method for obtaining polymer (P) in its ionic form as a powdery material, material (PP), said method comprising:
(1): providing the aqueous dispersion of claim 15; and
(2): contacting said aqueous dispersion with a basic hydrolysing agent to at least partially convert the hydrolysable groups of polymer (P) into corresponding ionic groups, without causing any significant coagulation, so as to obtain an aqueous dispersion of particles of polymer (P) in ionic form; and
optionally (3): contacting the dispersion obtained at the end of step (2) with at least one ion exchange resin, so as to at least partially remove residues of basic hydrolysing agent and/or other contaminants; and
(4): spray drying the dispersion obtained at the end of step (2) and the optional step (3) so as to obtain the material (PP).

17. The method of claim 16 in which the hydrolysable groups are groups —SO₂X and —COOZ, wherein X is a halogen atom and Z is a C₁-C₄ alkoxy group.

18. The method of claim 16 which comprises a further purification step which is performed between steps (2) and (4), when optional step (3) is present, between steps (3) and (4).

19. The method of claim 18 wherein the purification step is performed by means of one selected from dialysis, electrodialysis and ultrafiltration.

20. The method of claim 11, wherein the recurring units deriving from at least one hydrogenated and/or fluorinated monomer different from tetrafluoroethylene are selected from the group consisting of hexafluoropropylene, perfluoroalkylvinylethers of formula CF₂═CFOR′_{f1}, wherein R′_{f1} is a C₁-C₆ perfluoroalkyl; perfluoro-oxyalkylvinylethers of formula CF₂═CFOR′ₒ₁, wherein R′ₒ₁ is a C₂-C₁2 perfluoro-oxyalkyl having one or more ether groups, including perfluoroalkyl-methoxy-vinylethers of formula CF₂═CFOCF₂OR′_{f2} in which R′_{f2} is a C₁-C₆ perfluoroalkyl, or a C₁-C₆ perfluorooxyalkyl having one or more ether groups; and fluorodioxoles, of formula: 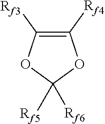
wherein
each of R_{f3}, R_{f4}, R_{f5}, R_{f6}, equal or different each other, is independently a fluorine atom, a C₁-C₆ fluoro(halo)fluoroalkyl, optionally comprising one or more oxygen atom.
